(19) United States
(12) Patent Application Publication
(10) Pub. No.: US 2020/0236596 A1
(43) Pub. Date: Jul. 23, 2020

(54) A BEARER SPLITTING METHOD, USER EQUIPMENT AND BASE STATION

(71) Applicant: MOKIA SOLUTIONS AND NETWORKS SYSTEM TECHNOLOGY (BEIJING) CO., LTD, Beijing (CN)

(72) Inventors: Yang LIU, Beijing (CN); Lei DU, Beijing (CN)

(21) Appl. No.: 16/652,847

(22) PCT Filed: Oct. 12, 2017
(86) PCT No.: PCT/CN2017/105862

§ 371 Date: Apr. 1, 2020

(51) Int. Cl. H04W 36/00; H04L 5/00; H04W 76/27

(52) U.S. Cl. CPC H04W 36/0069; H04W 76/27; H04L 5/0055; H04W 36/0058

(57) ABSTRACT

The present invention provides a bearer splitting method performed by user equipment and base station, and the corresponding user equipment and base station. A bearer splitting method performed by user equipment, comprising: carrying out measurement for one or more second base stations during the user equipment connecting to a first base station prior to network configuration; sending measurement results of at least part of the second base stations of the one or more second base stations to the first base station, such that the first base station selecting a target base station from the one or more second base stations according to the measurement results, wherein the target base station is used to control split bearer from the target and first base station to the user equipment.

### FIELD

The present invention relates to the technical field of communication, and particular to a bearer splitting method performed by user equipment and base station, and the corresponding user equipment and base station.

### BACKGROUND

In order to meet the increasing business requirements of users, it has been proposed to deploy secondary base stations (SeNB) intensively in the coverage area of a master base station (MeNB). Accordingly, with a user equipment (UE)'s location changing, frequent cell handover leads to a large amount of signaling overhead. Therefore, it has been proposed that the UE receives the user data from both the master base station and the secondary base station so as to minimize the signaling overhead and to boost capacity.

Incurrent communication system, there are several types of radio bearers could be used for load balancing, e.g. SCG (SeNB controlled group) bearer and split bearer. FIG. 1 illustrates the radio protocol for MCG and SCG bearer. As shown in FIG. 1, the master base station and the secondary base station both have independent PDCP layers, RLC layers and MAC layers, and the master base station and the secondary base station both receive data from MME directly through S1-U. FIG. 2 illustrates the radio protocol for split bearer. As shown in FIG. 2, the secondary base station only has RLC layer and MAC layer, and the master base station forwards the data received from CN/S-GW to the secondary base station through Xn. However, for both types of bearers, if MeNB needs to get the measurement result from UE, MeNB should configure the UE for measurement in advance after the RRC connection setup procedure completes and more signaling procedures are involved between MeNB and SeNB to establish the radio bearer. Therefore, it is obvious that the prior art introduces too much delay from UE or network perspective, especially for some of the 5G services which require less delay than the services in LTE. Moreover, the interaction of signaling between the master base station and the secondary base stations or the UE during the load balancing is tedious.

Therefore, the present disclosure provides a method and system which reduces signaling overhead and avoids the delay during the establishment of radio bearer.

### SUMMARY

According to one aspect of the present disclosure, a bearer splitting method performed by user equipment is provided. The method comprises: carrying out measurement for one or more second base stations during the user equipment connecting to a first base station prior to network configuration; sending measurement results of at least part of the second base stations of the one or more second base stations to the first base station, such that the first base station selecting a target base station from the one or more second base stations according to the measurement results, wherein the target base station is used to control split bearer from the target base station and the first base station to the user equipment.

According to another aspect of the present invention, a bearer splitting method performed by first base station is provided. The method comprises: receiving measurement results for one or more second base stations from a user equipment when the user equipment connecting to the first base station prior to network configuration; selecting a target base station from the one or more second base stations according to the measurement results for one or more second base stations, wherein the target base station is used to control split bearer from the target base station and the first base station to the user equipment.

According to another aspect of the present invention, a bearer splitting method performed by second base station is provided. The method comprises: receiving a SCG split bearer allowed indication from a first base station, wherein the second base station is used to control split bearer from the target base station and the first base station to the user equipment; sending a feedback information to the first base station.

According to another aspect of the present invention, a user equipment is provided. The user equipment comprises: measuring unit, configured to carry out measurement for one or more second base stations during the user equipment is connected to a first base station prior to network configuration; sending unit, configured to send measurement results of at least part of the second base stations of the one or more second base stations to the first base station, such that the first base station select a target base station from the one or more second base stations according to the measurement results, wherein the target base station is used to control split bearer from the target base station and the first base station to the user equipment.

According to another aspect of the present invention, a first base station is provided. The first base station comprises: receiving unit, configured to receive measurement results for one or more second base stations from a user equipment when the user equipment is connected to the first base station prior to network configuration; selecting unit, configured to select a target base station from the one or more second base stations according to the measurement results for one or more second base stations, wherein the target base station is used to control split bearer from the target base station and the first base station to the user equipment.

According to another aspect of the present invention, a second base station is provided. The second base station comprises: receiving unit, configured to receive a split bearer allowed indication from a first base station, wherein the second base station is used to control split bearer from the target base station and the first base station to the user equipment; and sending unit, configured to send a feedback information to the first base station.

In summary, based on the bearer splitting method performed by user equipment and the first base station, the present invention can set up a new split bearer which is split at SeNB instead of MeNB in LTE dual connectivity or multi-connectivity. The new split bearer would be to achieve the throughput enhancement by keeping the bearer in SeNB but on the other hand relieve the MeNB's backhaul interface. The optimized signalling procedure may reduce the signalling overhead in both Uu and X2, as well as shorten the delay for the whole procedure.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1 illustrates the radio protocol for SCG bearer.

FIG. 2 illustrates the radio protocol for split bearer.

FIG. 3 illustrates the radio protocol for split bearer according to an embodiment of the invention.

FIG. 4 illustrates a flowchart of a bearer splitting method performed by user equipment according to an embodiment of the invention.

FIG. 5 illustrates a flowchart of a bearer splitting method performed by a first base station according to an embodiment of the invention.

FIG. 6 illustrates a flowchart of a bearer splitting method performed by a second base station according to an embodiment of the invention.

FIG. 7 illustrates a method executed by the system comprising the user equipment, the master base station, the secondary base stations and the MME/S-GW according to an embodiment of the invention.

FIG. 8 is a block diagram illustrating the units of a user equipment for bearer splitting according to an embodiment of the invention.

FIG. 9 is a block diagram illustrating the units of a first base station for bearer splitting according to an embodiment of the invention.

FIG. 10 is a block diagram illustrating the units of a second base station for bearer splitting according to an embodiment of the invention.

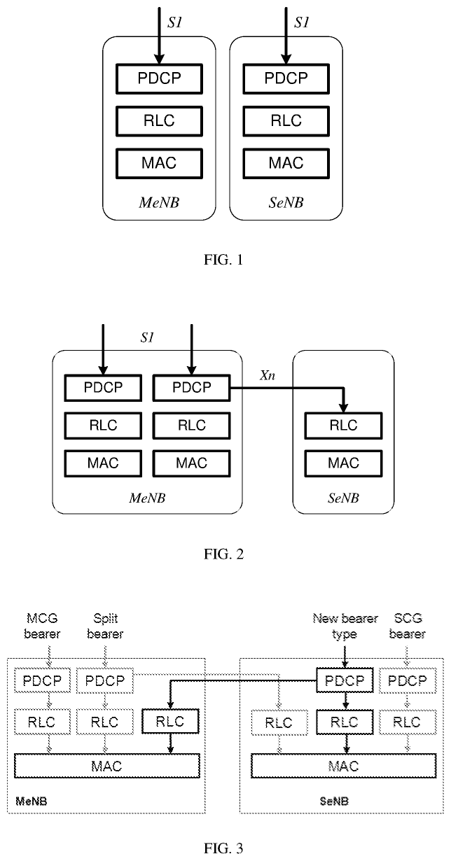

### DETAILED DESCRIPTION

Further scope of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

Herein, the item “base station” may also be expressed as “cell”, “access point”, “eNodeB” or “eNB”. Further, for example, the master base station (MeNB) may be a macro base station with a relatively larger transmit power and a relatively wider coverage. Furthermore, for example, the secondary base stations (SeNBs) may be small cells, microcells, picocells or femto cells with relatively smaller transmit powers and a relatively smaller coverage.

FIG. 3 illustrates the radio protocol for split bearer according to an embodiment of the invention. In one example of the present invention, it is proposed to introduce a new SCG split bearer as shown in FIG. 3, which is controlled by SeNB but using both radio from MeNB and SeNB. Based on the new split bearer, method and system which could reduce signaling overhead and avoid the delay during the establishment of radio bearer are proposed.

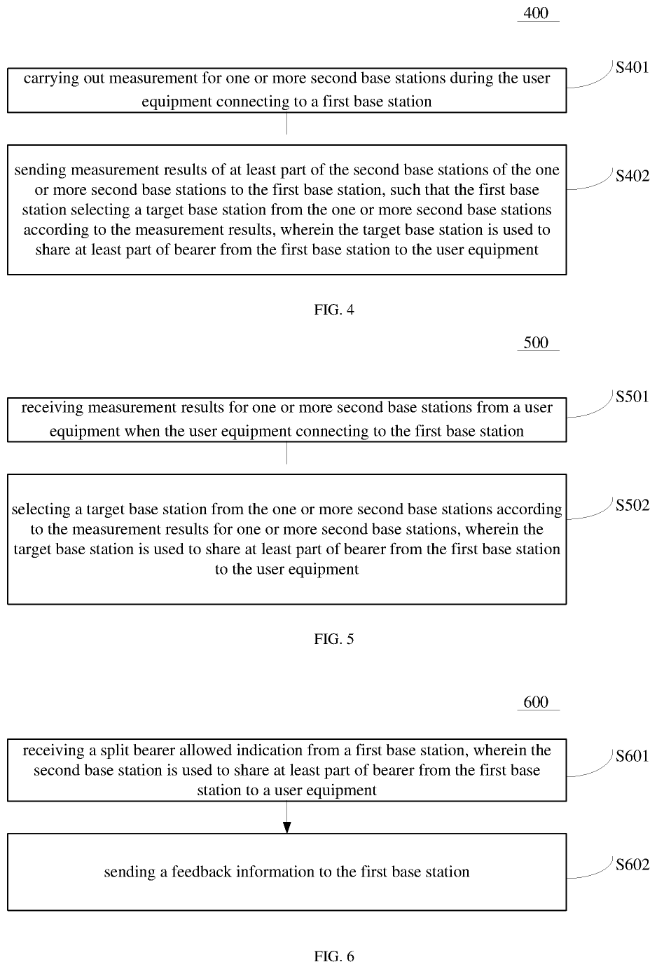

According to an aspect of the present invention, a bearer splitting method performed by a user equipment is provided, and illustrative embodiments of the bearer splitting method will be described in reference to FIG. 4.

FIG. 4 illustrates a flowchart of a bearer splitting method 400 performed by a user equipment according to an embodiment of the invention.

As shown in FIG. 4, in step S401, a UE carries out measurement for one or more second base stations during the user equipment connecting to a first base station prior to network configuration. That is, UE starts the measurement actively without any configuration from MeNB. Further, UE may carry out measurement immediately when UE connected to MeNB.

For example, the first base station could be master base station, and the second base station could be secondary base station. The network configuration may include the UE measurement configuration and/or connection related configuration. When UE starts to connect to MeNB, firstly, UE may send a RRC connection request to MeNB, and MeNB may send a RRC connection setup message to UE. Then, UE may carry out measurement for neighbouring SeNB(s) immediately when receives RRC connection setup message from MeNB. In one example of the present invention, UE may carry out measurement for one neighbouring SeNB; while in another example of the present invention, UE may carry out measurements for a plurality of neighbouring SeNBs. When UE starts to carry out the measurement, the configuration from the MeNB is not necessary, and this measurement may be handled based on pre-defined or default measurement rules which have already agreed between UE and MeNB. Therefore, UE could get the measurement result(s) of neighbouring SeNB(s) without measurement configuration from MeNB in the very beginning, which will reduces signaling overhead and avoids the delay during the establishment of dual connectivity or multi-connectivity.

In step S402, UE sends measurement results of at least part of the second base stations of the one or more second base stations to the first base station, such that the first base station selecting a target base station from the one or more second base stations according to the measurement results, wherein the target base station is used to control split bearer from the target base station and the first base station to the user equipment.

The measurement results of neighbouring SeNB(s) could be the measurement results of the channel quality between UE and SeNB(s), such as RSRP (Reference Signal Receiving Power), RSRQ (Reference Signal Received Quality), CQI (channel quality indicator) and/or SINR (Signal to Interference plus Noise Ratio). In one example of the present invention, UE may send the measurement results of all the neighbouring SeNB(s) to MeNB; in another example of the present invention, UE may send the measurement results of part of the neighbouring SeNB(s) to MeNB. For example, UE may select user equipment preferred second base stations from the neighbouring SeNB(s) according to the measurement results, to indicate to MeNB one or more target SeNB for dual/multi-connectivity operation. In this case, the at least part of the second base stations are the user equipment preferred second base stations, and UE may send the measurement results of the UE preferred second base stations to MeNB.

After UE finishes the measurement, UE may reply the RRC connection setup complete message to MeNB. The information of the measurement results and/or the UE preferred second base stations could be an independent measurement report sent to MeNB, or contained in the RRC connection setup complete message.

When MeNB receives the measurement results and/or the UE preferred second base stations from UE, MeNB may select appropriate target base station from the received second base station(s) for this UE according to the measurement results or the UE preferred second base stations. Specifically, MeNB may send a split bearer allowed indication to the target base station, and get a feedback information from the target base station. When the target base station decides to establish the split bearer, MeNB could get the split bearer acknowledgement information from the feedback information and configure the UE with the new split bearer to indicate to UE that this is a different bearer from the legacy split bearer at MeNB (if any), e.g. via configuring new DRB (data radio bearer) lds, to allow UE being able to differentiate it from other bearers in the UE. For example, UE may receive a split bearer indication with respect to the target base station from MeNB, and then, UE may receive the bearer data both from the target base station and the master base station according to the split bearer indication.

Therefore, according to the split bearer method of the present invention, a new type of split bear could be established with the least requires steps which save both signalling and time during the whole procedure.

According to another aspect of the present invention, a bearer splitting method performed by first base station is provided, and illustrative embodiments of the bearer splitting method will be described in reference to FIG. 5. Herein after, for example, the first base station could be master base station, and the second base station could be secondary base station.

FIG. 5 illustrates a flowchart of a bearer splitting method 500 performed by a first base station according to an embodiment of the invention.

As shown in FIG. 5, in step S501, a first base station receiving measurement results for one or more second base stations from a user equipment when the user equipment connecting to the first base station prior to network configuration.

According to an example of the embodiment, before step S501, UE may carry out measurement for one or more neighbouring SeNB, and send the measurement results to MeNB. Wherein, UE may select user equipment preferred second base stations from the neighbouring SeNB(s) according to the measurement results, to indicate to MeNB one or more target SeNB for dual connectivity operation. In this case, the at least part of the second base stations are the user equipment preferred second base stations, and UE may send the measurement results of the UE preferred second base stations to MeNB.

In step S501, after UE finishes the measurement, the first base station (MeNB) may receive measurement results for one or more second base stations from UE prior to network configuration. For example, the network configuration may include the UE measurement configuration and/or connection related configuration. The information of the measurement results and/or the UE preferred second base stations could be an independent measurement report sent to MeNB, or contained in the RRC connection setup complete message.

In step S502, the first base station selects a target base station from the one or more second base stations according to the measurement results for one or more second base stations, wherein the target base station is used to control split bearer from the target base station and the first base station to the user equipment.

For example, MeNB may select appropriate target base station from the received second base station(s) for this UE by triggering the target base station addition request procedure according to the measurement results or the UE preferred second base stations. In one example of the present invention, MeNB may send a split bearer allowed indication to the target base station, to indicate the target base station that the split bearer is allowed for this operation. The target base station is used to control the split bearer from the target and first base station to the user equipment. Therefore, the MeNB could be able to get the first-hand useful information on UE's available neighbouring SeNBs and make the choice without further configuration UE on the measurement (as well as waiting measurement report from UE) based on the information from UE, and the signaling overhead could be reduced and the delay could be avoided.

In other example of the present invention, before the selection of the MeNB for the target base station, MeNB may trigger initial UE message towards MME/S-GW and completes the authentication procedure between UE and MME/S-GW which lead to establishment of UE context information at MeNB.

When the target base station receives the split bearer allowed indication from the MeNB, the target base station may send a feedback information to the MeNB. For details, when the target base station decides to establish the split bearer, the target base station may reply with split bearer acknowledgement information to MeNB to trigger the split bearer at the target base station. However, when the target base station decides not to establish the split bearer, the target base station may reply with split bearer non-acknowledgement information to the MeNB, and the MeNB could select one or more other SeNB to trigger the split bearer. When the target base station decides to establish the split bearer, the target base station may also inform MeNB about the bearer data volume to be routed via the target base station's link (towards UE) by the feedback information, so that the MeNB could know how to deal with the coming data forwarding later on. In one example of the present invention, the feedback information from the target base station may includes a bearer data volume threshold of the target base station, and the MeNB could determine the feedback information from the target base station is the split bearer acknowledgement information when the bearer data volume threshold of the target base station is more than or equal to the split bearer accepted by the first base station, wherein MeNB could inform the SeNB about the split bearer accepted by the MeNB by the split bearer allowed indication before.

For example, when the split bearer accepted by the MeNB is 5 kbit, while the bearer data volume threshold of the target base station included in the feedback information is also 5 kbit, the MeNB determines the feedback information from the target base station is the split bearer acknowledgement information, and the split bearer could be successfully established. However, when the split bearer accepted by the MeNB is 5 kbit, while the bearer data volume threshold of the target base station included in the feedback information is only 2 kbit, the MeNB determines the feedback information from the target base station is not the split bearer acknowledgement information, and the split bearer could not be successfully established. Negotiate with the target secondary base station about the requested data volume in SeNB in advance, could avoid the back and forth data forwarding between MeNB and SeNB regarding the new split bearer.

When MeNB determines the split bearer could be successfully established, the MeNB could configure the UE with the new split bearer to indicate to UE that this is a different bearer from the legacy split bearer at MeNB (if any), e.g. via configuring new DRB (data radio bearer) lds, to allow UE being able to differentiate it from other bearers in the UE. Specifically, MeNB may send asplit bearer indication with respect to the target base station to the user equipment when receiving a split bearer acknowledgement information from the target base station, and then, MeNB could send a split bearer setup complete message and do the data forwarding towards the target base station, in such a way that the target base station would be able to accept these data and MeNB could deliver the rest traffic to UE, as part of the new split bearer. Wherein, the bearer data volume which forwarded to the target base station by the MeNB could be based on the bearer data volume threshold of the target base station. Then, UE may receive the bearer data both from the target base station and the master base station according to the split bearer indication.

Therefore, according to the split bearer method of the present invention, a new type of split bear could be established with the least requires steps which saves both signalling and time during the whole procedure.

According to another aspect of the present invention, a bearer splitting method performed by a second base station is provided, and illustrative embodiments of the bearer splitting method will be described in reference to FIG. 6.

FIG. 6 illustrates a flowchart of a bearer splitting method 600 performed by a second base station according to an embodiment of the invention. Herein after, for example, the first base station could be master base station, and the second base station could be secondary base station.

As shown in FIG. 6, in step S601, a second base station receives a split bearer allowed indication from a first base station, wherein the second base station is used to control split bearer from the target base station and the first base station to the user equipment.

According to an example of the embodiment, before S601, UE may carry out measurement for one or more neighbouring SeNB prior to network configuration, and send the measurement results to MeNB. Wherein, the network configuration may include the UE measurement configuration and/or connection related configuration, and UE may select user equipment preferred second base stations from the neighbouring SeNB(s) according to the measurement results, to indicate to MeNB one or more target SeNB for dual connectivity operation. In this case, the at least part of the second base stations are the user equipment preferred second base stations, and UE may send the measurement results of the UE preferred second base stations to MeNB.

After UE finishes the measurement, the first base station (MeNB) may receive measurement results for one or more second base stations from UE. The information of the measurement results and/or the UE preferred second base stations could be an independent measurement report sent to MeNB, or contained in the RRC connection setup complete message.

Then, the first base station selects a target base station from the one or more second base stations according to the measurement results for one or more second base stations, wherein the target base station is used to control the split bearer from the target and first base station to the user equipment. After that, in step S601, as a target base station, a second base station receives a split bearer allowed indication from a first base station, wherein the second base station is used to share at least part of bearer from the first base station to a user equipment.

In step S602, the second base station sends a feedback information to the first base station.

When the second base station as a target base station receives the split bearer allowed indication from the MeNB, the target base station may send a feedback information to the MeNB. For details, when the target base station decides to establish the split bearer, the target base station may reply with split bearer acknowledgement information to MeNB to trigger the split bearer at the target base station. However, when the target base station decides not to establish the split bearer, the target base station may reply with split bearer non-acknowledgement information to the MeNB, and the MeNB could select one or more other SeNB to trigger the split bearer. When the target base station decides to establish the split bearer, the target base station may also inform MeNB about the bearer data volume to be routed via the target base station's link (towards UE) by the feedback information, so that the MeNB could know how to deal with the coming data forwarding later on. In one example of the present invention, the feedback information from the target base station may includes a bearer data volume threshold of the target base station, and the MeNB could determine the feedback information from the target base station is the split bearer acknowledgement information when the bearer data volume threshold of the target base station is more than or equal to the split bearer accepted by the first base station, wherein MeNB could inform the SeNB about the split bearer accepted by the MeNB by the split bearer allowed indication before.

For example, when the split bearer accepted by the MeNB is 5 kbit, while the bearer data volume threshold of the target base station included in the feedback information is also 5 kbit, the MeNB determines the feedback information from the target base station is the split bearer acknowledgement information, and the split bearer could be successfully established. However, when the split bearer accepted by the MeNB is 5 kbit, while the bearer data volume threshold of the target base station included in the feedback information is only 2 kbit, the MeNB determines the feedback information from the target base station is not the split bearer acknowledgement information, and the split bearer could not be successfully established. Negotiate with the target secondary base station about the requested data volume in SeNB in advance, could avoid the back and forth data forwarding between MeNB and SeNB regarding the new split bearer.

When MeNB determines the split bearer could be successfully established, the MeNB could configure the UE with the new split bearer to indicate to UE that this is a different bearer from the legacy split bearer at MeNB (if any), e.g. via configuring new DRB (data radio bearer) lds, to allow UE being able to differentiate it from other bearers in the UE. Specifically, MeNB may send a split bearer indication with respect to the target base station to the user equipment when receiving a split bearer acknowledgement information from the target base station, and then, MeNB could do the data forwarding towards the target base station, in such a way that the target base station would be able to accept these data and MeNB could deliver the rest traffic to UE, as part of the new split bearer. Wherein, the bearer data volume which forwarded to the target base station by the MeNB could be based on the bearer data volume threshold of the target base station. Then, UE may receive the bearer data both from the target base station and the master base station according to the split bearer indication.

Therefore, according to the split bearer method of the present invention, new type of split bear could be established with the least requires steps which saves both signalling and time during the whole procedure.

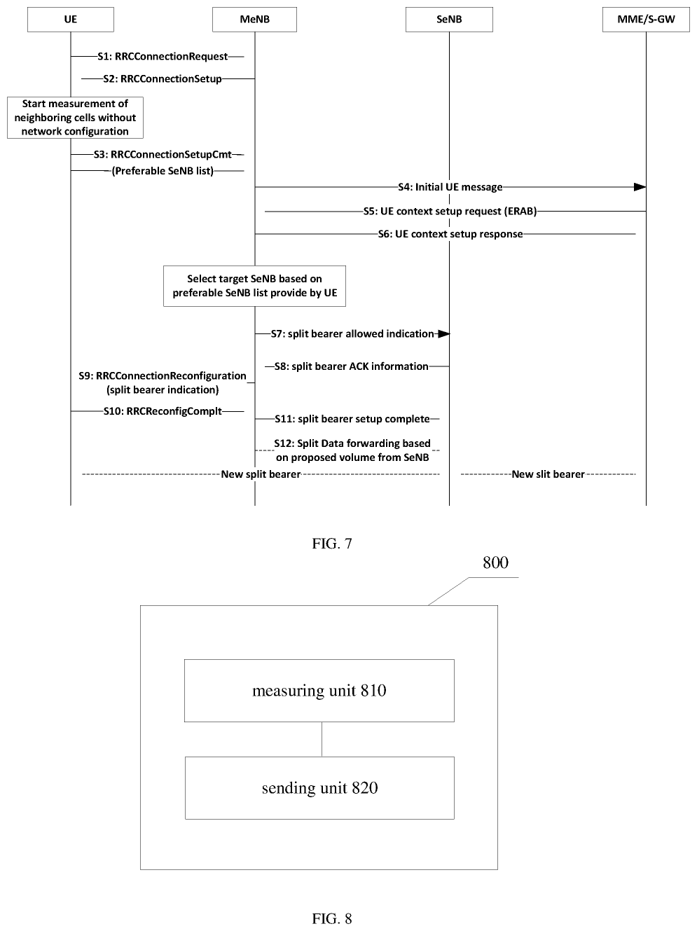

FIG. 7 illustrates the method executed by the system comprising the user equipment, the master base station, the secondary base stations and the MME/S-GW. As shown in FIG. 7, in step S1, when UE starts to connect to MeNB, UE sends a RRC connection request to MeNB, and in step S2, MeNB sends a RRC connection setup message to UE. Then, UE carries out measurement for neighbouring SeNB(s) immediately when receives RRC connection setup message from MeNB. In one example of the present invention, UE may carry out measurement for one neighbouring SeNB; while in another example of the present invention, UE may carry out measurements for a plurality of neighbouring SeNBs. When UE starts to carry out the measurement, the configuration from the MeNB is not necessary, and this measurement may be handled based on pre-defined or default measurement rules which have already agreed between UE and MeNB. Therefore, UE could get the measurement result(s) of neighbouring SeNB(s) without measurement configuration from MeNB in the very beginning, which will reduces signaling overhead and avoids the delay during the establishment of dual connectivity or multi-connectivity.

In step S3, after UE finishes the measurement, UE replies the RRC connection setup complete message to MeNB. In this step, the information of the measurement results and/or the UE preferred SeNBs could be an independent measurement report sent to MeNB, or contained in the RRC connection setup complete message.

When MeNB receives the measurement results and/or the UE preferred SeNBs from UE, in step S4, MeNB sends Initial UE message to MME/S-GW. After that, in step S5, MME/S-GW sends UE context setup request (ERAB) and in step S6, MeNB replies UE context setup response. Therefore, MeNB completes the authentication procedure between UE and MME/S-GW. Then, MeNB selects appropriate target base station(s) from the received SeNB(s) for this UE according to the measurement results or the UE preferred SeNBs. In step S7, MeNB sends a split bearer allowed indication to the target base station (SeNB shown in FIG. 7), to indicate the SeNB that the split bearer is allowed for this operation. When the SeNB receives the split bearer allowed indication from the MeNB, in step S8, the SeNB sends a split bearer acknowledgement (ACK) information to MeNB to trigger the split bearer at the SeNB. Specifically, the SeNB may also inform MeNB about the bearer data volume to be routed via the split bearer ACK information, so that the MeNB could know how to deal with the coming data forwarding later on.

When MeNB determines the split bearer could be successfully established, in step S9, the MeNB sends a split bearer indication via RRC connection reconfiguration to allow UE being able to differentiate it from other bearers in the UE, and then, in step S10, UE replies RRC reconfiguration complete message to MeNB. After that, in step S11, MeNB sends a split bearer setup complete message to SeNB, and in step S12, MeNB does the data forwarding towards the SeNB, in such a way that the SeNB would be able to accept these data and MeNB could deliver the rest traffic to UE, as part of the new split bearer. Then, UE may receive the bearer data both from the SeNB and the master base station according to the split bearer indication, and the new split bearer is successfully established.

FIG. 8 is a block diagram illustrating the units of a user equipment for bearer splitting according to an embodiment of the present disclosure. As shown in FIG. 8, the user equipment (800) comprises a measuring unit (810) configured to carry out measurement for one or more second base stations during the user equipment is connected to a first base station prior to network configuration; and a sending unit (820) configured to send measurement results of at least part of the second base stations of the one or more second base stations to the first base station, such that the first base station select a target base station from the one or more second base stations according to the measurement results, wherein the target base station is used to control split bearer from the target base station and the first base station to the user equipment. Further, in addition to the measuring unit (810) and the sending unit (820), the user equipment may further comprise other units that can be used to implement communication with the MeNB and/or the SeNB. Since these units are irrelevant of the embodiment of the present disclosure, they are not shown or depicted herein.

According to an example of the embodiment, the measuring unit (810) carries out measurement for one or more second base stations during the user equipment connecting to a first base station prior to network configuration. That is, UE starts the measurement actively without any configuration from MeNB. Further, UE may carry out measurement immediately when UE connected to MeNB.

For example, the first base station could be master base station, and the second base station could be secondary base station. The network configuration may include the UE measurement configuration and/or connection related configuration. When UE starts to connect to MeNB, firstly, UE may send a RRC connection request to MeNB, and MeNB may send a RRC connection setup message to UE. Then, UE may carry out measurement for neighbouring SeNB(s) immediately when receives RRC connection setup message from MeNB. In one example of the present invention, the measuring unit (810) may carry out measurement for one neighbouring SeNB; while in another example of the present invention, the measuring unit (810) may carry out measurements for a plurality of neighbouring SeNBs. When the measuring unit (810) starts to carry out the measurement, the configuration from the MeNB is not necessary, and this measurement may be handled based on pre-defined or default measurement rules which have already agreed between UE and MeNB. Therefore, UE could get the measurement result(s) of neighbouring SeNB(s) without measurement configuration from MeNB in the very beginning, which will reduces signaling overhead and avoids the delay during the establishment of dual connectivity or multi-connectivity.

The sending unit (820) sends measurement results of at least part of the second base stations of the one or more second base stations to the first base station, such that the first base station selecting a target base station from the one or more second base stations according to the measurement results, wherein the target base station is used to control split bearer from the target base station and the first base station to the user equipment.

The measurement results of neighbouring SeNB(s) could be the measurement results of the channel quality between UE and SeNB(s), such as RSRP (Reference Signal Receiving Power), RSRQ (Reference Signal Received Quality), CQI (channel quality indicator) and/or SINR (Signal to Interference plus Noise Ratio). In one example of the present invention, the sending unit (820) may send the measurement results of all the neighbouring SeNB(s) to MeNB; in another example of the present invention, the sending unit (820) may send the measurement results of part of the neighbouring SeNB(s) to MeNB. For example, UE may select user equipment preferred second base stations from the neighbouring SeNB(s) according to the measurement results, to indicate to MeNB one or more target SeNB for dual/multi-connectivity operation. In this case, the at least part of the second base stations are the user equipment preferred second base stations, and UE may send the measurement results of the UE preferred second base stations to MeNB.

After UE finishes the measurement, the sending unit (820) may reply the RRC connection setup complete message to MeNB. The information of the measurement results and/or the UE preferred second base stations could be an independent measurement report sent to MeNB, or contained in the RRC connection setup complete message.

When MeNB receives the measurement results and/or the UE preferred second base stations from UE, MeNB may select appropriate target base station from the received second base station(s) for this UE according to the measurement results or the UE preferred second base stations. Specifically, MeNB may send a split bearer allowed indication to the target base station, and get a feedback information from the target base station. When the target base station decides to establish the split bearer, MeNB could get the split bearer acknowledgement information from the feedback information and configure the UE with the new split bearer to indicate to UE that this is a different bearer from the legacy split bearer at MeNB (if any), e.g. via configuring new DRB (data radio bearer) lds, to allow UE being able to differentiate it from other bearers in the UE. For example, UE may further comprise a receiving unit (not shown), configured to receive a split bearer indication with respect to the target base station from MeNB, and then, the receiving unit may receive the bearer data both from the target base station and the master base station according to the split bearer indication.

Therefore, according to the user equipment of the present invention, a new type of split bear could be established with the least requires steps which save both signalling and time during the whole procedure.

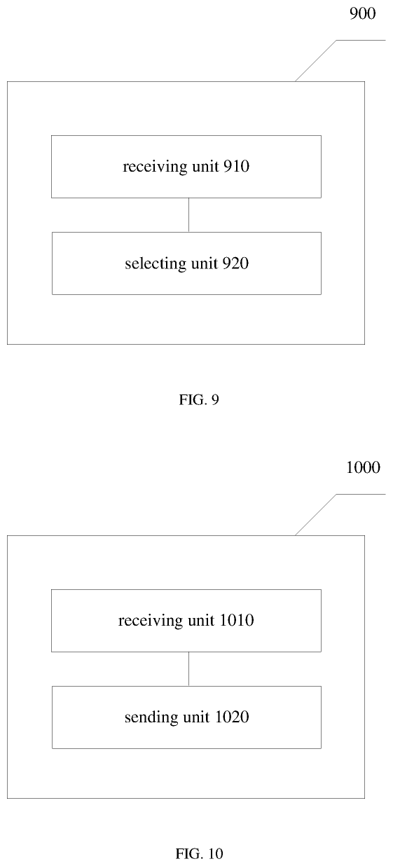

FIG. 9 is a block diagram illustrating the units of a first base station for bearer splitting according to an embodiment of the present disclosure. Herein after, for example, the first base station could be master base station, and the second base station could be secondary base station. As shown in FIG. 9, the first base station (900) comprises a receiving unit (910) configured to receive measurement results for one or more second base stations from a user equipment when the user equipment is connected to the first base station prior to network configuration; and a selecting unit (920) configured to select a target base station from the one or more second base stations according to the measurement results for one or more second base stations, wherein the target base station is used to control split bearer from the target base station and the first base station to the user equipment. Further, in addition to the receiving unit (910) and the selecting unit (920), the first base station may further comprise other units that can be used to implement communication with the UE and/or the SeNB. Since these units are irrelevant of the embodiment of the present disclosure, they are not shown or depicted herein.

According to an example of the embodiment, the receiving unit (810) configured to receive measurement results for one or more second base stations from a user equipment when the user equipment connecting to the first base station prior to network configuration.

According to an example of the embodiment, before the receiving unit receives the measurement results, UE may carry out measurement for one or more neighbouring SeNB, and send the measurement results to MeNB. Wherein, UE may select user equipment preferred second base stations from the neighbouring SeNB(s) according to the measurement results, to indicate to MeNB one or more target SeNB for dual connectivity operation. In this case, the at least part of the second base stations are the user equipment preferred second base stations, and UE may send the measurement results of the UE preferred second base stations to MeNB.

After UE finishes the measurement, the receiving unit of the first base station (MeNB) may receive measurement results for one or more second base stations from UE prior to network configuration. For example, the network configuration may include the UE measurement configuration and/or connection related configuration. The information of the measurement results and/or the UE preferred second base stations could be an independent measurement report sent to MeNB, or contained in the RRC connection setup complete message.

The selecting unit (920) selects a target base station from the one or more second base stations according to the measurement results for one or more second base stations, wherein the target base station is used to control the split bearer from the target and first base station to the user equipment.

For example, the selecting unit (920) may select appropriate target base station from the received second base station(s) for this UE by triggering the target base station addition request procedure according to the measurement results or the UE preferred second base stations. In one example of the present invention, MeNB may further comprises a sending unit (not shown), configured to send a split bearer allowed indication to the target base station, to indicate the target base station that the split bearer is allowed for this operation. The target base station is used to control the split bearer from the target and first base station to the user equipment. Therefore, the MeNB could be able to get the first-hand useful information on UE's available neighbouring SeNBs and make the choice without further configuration UE on the measurement (as well as waiting measurement report from UE) based on the information from UE, and the signaling overhead could be reduced and the delay could be avoided.

In other example of the present invention, before the selection of the MeNB for the target base station, MeNB may trigger initial UE message towards MME/S-GW and completes the authentication procedure between UE and MME/S-GW which lead to establishment of UE context information at MeNB.

When the target base station receives the split bearer allowed indication from the MeNB, the target base station may send a feedback information to the MeNB. For details, when the target base station decides to establish the split bearer, the target base station may reply with split bearer acknowledgement information to MeNB to trigger the split bearer at the target base station. However, when the target base station decides not to establish the split bearer, the target base station may reply with split bearer non-acknowledgement information to the MeNB, and the selecting unit (920) could select one or more other SeNB to trigger the split bearer. When the target base station decides to establish the split bearer, the target base station may also inform MeNB about the bearer data volume to be routed via the target base station's link (towards UE) by the feedback information, so that the selecting unit (920) could know how to deal with the coming data forwarding later on. In one example of the present invention, the feedback information from the target base station may includes a bearer data volume threshold of the target base station, and the selecting unit (920) could determine the feedback information from the target base station is the split bearer acknowledgement information when the bearer data volume threshold of the target base station is more than or equal to the split bearer accepted by the first base station, wherein MeNB could inform the SeNB about the split bearer accepted by the MeNB by the split bearer allowed indication before.

For example, when the split bearer accepted by the MeNB is 5 kbit, while the bearer data volume threshold of the target base station included in the feedback information is also 5 kbit, the selecting unit (920) determines the feedback information from the target base station is the split bearer acknowledgement information, and the split bearer could be successfully established. However, when the split bearer accepted by the MeNB is 5 kbit, while the bearer data volume threshold of the target base station included in the feedback information is only 2 kbit, the selecting unit (920) determines the feedback information from the target base station is not the split bearer acknowledgement information, and the split bearer could not be successfully established. Negotiate with the target secondary base station about the requested data volume in SeNB in advance, could avoid the back and forth data forwarding between MeNB and SeNB regarding the new split bearer.

When selecting unit (920) determines the split bearer could be successfully established, the sending unit could configure the UE with the new split bearer to indicate to UE that this is a different bearer from the legacy split bearer at MeNB (if any), e.g. via configuring new DRB (data radio bearer) lds, to allow UE being able to differentiate it from other bearers in the UE. Specifically, the sending unit may send asplit bearer indication with respect to the target base station to the user equipment when receiving a split bearer acknowledgement information from the target base station, and then, the sending unit could send a split bearer setup complete message and do the data forwarding towards the target base station, in such a way that the target base station would be able to accept these data and MeNB could deliver the rest traffic to UE, as part of the new split bearer. Wherein, the bearer data volume which forwarded to the target base station by the MeNB could be based on the bearer data volume threshold of the target base station. Then, UE may receive the bearer data both from the target base station and the master base station according to the split bearer indication.

Therefore, according to the first base station of the present invention, a new type of split bear could be established with the least requires steps which save both signalling and time during the whole procedure.

FIG. 10 is a block diagram illustrating the units of a second base station for bearer splitting according to an embodiment of the present disclosure. Herein after, for example, the first base station could be master base station, and the second base station could be secondary base station. As shown in FIG. 10, the second base station (1000) comprises a receiving unit (1010) configured to receives a split bearer allowed indication from a first base station, wherein the second base station is used to control split bearer from the target base station and the first base station to the user; and a sending unit (1020) configured to sends a feedback information to the first base station. Further, in addition to the receiving unit (1010) and the sending unit (1020), the second base station may further comprise other units that can be used to implement communication with the MeNB and/or the UE. Since these units are irrelevant of the embodiment of the present disclosure, they are not shown or depicted herein.

According to an example of the embodiment, the receiving unit (1010) receives a split bearer allowed indication from a first base station, wherein the second base station is used to control split bearer from the target base station and the first base station to the user.

According to an example of the embodiment, before the receiving unit (1010) receives a split bearer allowed indication from a first base station, UE may carry out measurement for one or more neighbouring SeNB prior to network configuration, and send the measurement results to MeNB. Wherein, the network configuration may include the UE measurement configuration and/or connection related configuration, and UE may select user equipment preferred second base stations from the neighbouring SeNB(s) according to the measurement results, to indicate to MeNB one or more target SeNB for dual connectivity operation. In this case, the at least part of the second base stations are the user equipment preferred second base stations, and UE may send the measurement results of the UE preferred second base stations to MeNB.

After UE finishes the measurement, the first base station (MeNB) may receive measurement results for one or more second base stations from UE. The information of the measurement results and/or the UE preferred second base stations could be an independent measurement report sent to MeNB, or contained in the RRC connection setup complete message.

Then, the first base station selects a target base station from the one or more second base stations according to the measurement results for one or more second base stations, wherein the target base station is used to control the split bearer from the target and first base station to the user equipment. After that, the receiving unit (1010) of a second base station which is selected as a target base station, receives a split bearer allowed indication from a first base station, wherein the second base station is used to share at least part of bearer from the first base station to a user equipment.

The sending unit (1020) sends a feedback information to the first base station.

When the second base station as a target base station receives the split bearer allowed indication from the MeNB, the sending unit (1020) of the target base station may send a feedback information to the MeNB. For details, when the target base station decides to establish the split bearer, the sending unit (1020) of the target base station may reply with split bearer acknowledgement information to MeNB to trigger the split bearer at the target base station. However, when the target base station decides not to establish the split bearer, the sending unit (1020) of the target base station may reply with split bearer non-acknowledgement information to the MeNB, and the MeNB could select one or more other SeNB to trigger the split bearer. When the target base station decides to establish the split bearer, the sending unit (1020) of the target base station may also inform MeNB about the bearer data volume to be routed via the target base station's link (towards UE) by the feedback information, so that the MeNB could know how to deal with the coming data forwarding later on. In one example of the present invention, the feedback information from the target base station may includes a bearer data volume threshold of the target base station, and the MeNB could determine the feedback information from the target base station is the split bearer acknowledgement information when the bearer data volume threshold of the target base station is more than or equal to the split bearer accepted by the first base station, wherein MeNB could inform the SeNB about the split bearer accepted by the MeNB by the split bearer allowed indication before.

For example, when the split bearer accepted by the MeNB is 5 kbit, while the bearer data volume threshold of the target base station included in the feedback information is also 5 kbit, the MeNB determines the feedback information from the target base station is the split bearer acknowledgement information, and the split bearer could be successfully established. However, when the split bearer accepted by the MeNB is 5 kbit, while the bearer data volume threshold of the target base station included in the feedback information is only 2 kbit, the MeNB determines the feedback information from the target base station is not the split bearer acknowledgement information, and the split bearer could not be successfully established. Negotiate with the target secondary base station about the requested data volume in SeNB in advance, could avoid the back and forth data forwarding between MeNB and SeNB regarding the new split bearer.

When MeNB determines the split bearer could be successfully established, the MeNB could configure the UE with the new split bearer to indicate to UE that this is a different bearer from the legacy split bearer at MeNB (if any), e.g. via configuring new DRB (data radio bearer) lds, to allow UE being able to differentiate it from other bearers in the UE. Specifically, MeNB may send a split bearer indication with respect to the target base station to the user equipment when receiving a split bearer acknowledgement information from the target base station, and then, MeNB could do the data forwarding towards the target base station, in such a way that the target base station would be able to accept these data and MeNB could deliver the rest traffic to UE, as part of the new split bearer. Wherein, the bearer data volume which forwarded to the target base station by the MeNB could be based on the bearer data volume threshold of the target base station. Then, UE may receive the bearer data both from the target base station and the master base station according to the split bearer indication.

Therefore, according to the second base station of the present invention, new type of split bear could be established with the least requires steps which saves both signalling and time during the whole procedure.

For people skilled in the art, the bearer splitting method, user equipment and base station can be used in the following communication systems without paying creative work, such as LTE, LTE-Advanced, Wideband Code-Division Multiple Access (WCDMA), Global System for Mobile communications/Enhanced Data rate for GSM Evolution (GSM/EDGE), or GSM network, 5G or other network or system.

The method and apparatus for bearer splitting according to the embodiments of the present disclosure have been descried hereinabove. It should be appreciated that these embodiments are only illustrative, rather than limitative. Further, it will be readily apparent to a person skilled in the art that the methods, the elements, units and apparatuses described in connection with embodiments of the invention may be implemented in hardware, in software, or as a combination of both. In particular it will be appreciated that the embodiments of the invention may be implemented by a computer program or computer programs running on a computer or being executed by a microprocessor. Any apparatus implementing the invention may in particular take the form of a computing device.

Moreover, the exemplary embodiments of the present disclosure have been shown and described, but a person skilled in the art should appreciate that various changes in forms and details may be made to these exemplary embodiments without departing from the scope and spirit of the present disclosure as defined in the claims and equivalents thereof.

1. A bearer splitting method performed by user equipment, comprising:
carrying out measurement for one or more second base stations during the user equipment connecting to a first base station prior to network configuration;
sending measurement results of at least part of the second base stations of the one or more second base stations to the first base station, such that the first base station selecting a target base station from the one or more second base stations according to the measurement results, wherein the target base station is used to control split bearer from the target base station and the first base station to the user equipment.

2. The method according to claim 1, wherein the method further comprises:
receiving a split bearer indication with respect to the target base station from the first base station;
receiving information from the target base station according to the split bearer indication.

3. The method according to claim 1, wherein the method further comprises:
selecting user equipment preferred second base stations from the one or more second base stations according to the measurement results of the one or more second base stations;
wherein, the at least part of the second base stations are the user equipment preferred second base stations.

4. A bearer splitting method performed by first base station, comprising:
receiving measurement results for one or more second base stations from a user equipment when the user equipment connecting to the first base station prior to network configuration;
selecting a target base station from the one or more second base stations according to the measurement results for one or more second base stations, wherein the target base station is used to control split bearer from the target base station and the first base station to the user equipment.

5. The method according to claim 4, wherein the method further comprises:
sending a split bearer allowed indication to the target base station;
sending a split bearer indication with respect to the target base station to the user equipment when receiving a split bearer acknowledgement information from the target base station.

6. The method according to claim 5, wherein the sending a split bearer indication with respect to the target base station to the user equipment when receiving a split bearer acknowledgement information from the target base station further comprises:
receiving a feedback information from the target base station;
determining data volume accepted in the first base station based on feedback information from the target base station, and determining whether or not the feedback information from the target base station is the split bearer acknowledgement information.

7. The method according to claim 6, wherein,
the feedback information from the target base station including a bearer data volume threshold of the target base station;
the determining data volume accepted in the first base station based on feedback information from the target base station comprising:
when the bearer data volume threshold of the target base station is more than or equal to the split bearer accepted by the first base station, determining the feedback information from the target base station is the split bearer acknowledgement information.

8. A user equipment, comprises:
measuring unit, configured to carry out measurement for one or more second base stations during the user equipment is connected to a first base station prior to network configuration;
sending unit, configured to send measurement results of at least part of the second base stations of the one or more second base stations to the first base station, such that the first base station select a target base station from the one or more second base stations according to the measurement results, wherein the target base station is used to control split bearer from the target base station and the first base station to the user equipment.

9. The user equipment according to claim 8, further comprises:
receiving unit, configured to receive a split bearer indication with respect to the target base station from the first base station;
receive information from the target base station according to the split bearer indication.

10. The user equipment according to claim 8, wherein:
the measuring unit select user equipment preferred second base stations from the one or more second base stations according to the measurement results of the one or more second base stations;
wherein, the at least part of the second base stations are the user equipment preferred second base stations.

11. First base station, comprises:
receiving unit, configured to receive measurement results for one or more second base stations from a user equipment when the user equipment is connected to the first base station prior to network configuration;
selecting unit, configured to select a target base station from the one or more second base stations according to the measurement results for one or more second base stations, wherein the target base station is used to control split bearer from the target base station and the first base station to the user equipment.

12. The first base station according to claim 11, further comprises:
sending unit, configured to send a split bearer allowed indication to the target base station;
send a split bearer indication with respect to the target base station to the user equipment when receive a split bearer acknowledgement information from the target base station.

13. The first base station according to claim 12, wherein,
the receiving unit receive a feedback information from the target base station;
the sending unit determine data volume accepted in the first base station based on feedback information from the target base station and determine whether or not the feedback information from the target base station is the split bearer acknowledgement information.

14. The first base station according to claim 13, wherein,
the feedback information from the target base station including a bearer data volume threshold of the target base station;
when the bearer data volume threshold of the target base station is more than or equal to the split bearer accepted by the first base station, the sending unit determine the feedback information from the target base station is the split bearer acknowledgement information.
